(19) United States
(12) Patent Application Publication
(10) Pub. No.: US 2023/0151857 A1
(43) Pub. Date: May 18, 2023

(54) BRAKE PAD FOR A DISK BRAKE SYSTEM AND DISK BRAKE SYSTEM

(71) Applicant: HL MANDO CORPORATION, Pyeongtaek-si (KR)

(72) Inventors: Hatem SHAHIN, Pfaffenhofen (DE); Lothar WAGNER, Simmern (DE); Kai BRAUN, Friedrichsdorf (DE)

(73) Assignee: HL MANDO CORPORATION, Pyeongtaek-si (KR)

(21) Appl. No.: 18/083,747

(22) Filed: Dec. 19, 2022

(30) Foreign Application Priority Data
Nov. 17, 2021 (DE) 102021214642.2

(51) Int. Cl. F16D 65/095

(52) U.S. Cl. CPC F16D 65/095; F16D 55/22

(57) ABSTRACT

The application relates to a brake pad (2) for a disk brake system and to a disk brake system. The proposed brake pad (2) comprises a back plate (5) having a front side (4) for facing a brake disk (1) of the disk brake system and a friction layer (3) arranged on the front side (4) of the back plate (5) for contacting a friction surface of the brake disk (1). The back plate (5) comprises a guiding protrusion (9) configured to be slidably received within a guiding recess (14) of a carrier (13) of the disk brake system. The guiding protrusion (9) of the back plate (5) comprises a bulging portion (10). The bulging portion (10) is configured to extend toward a guiding surface (15) of the guiding recess (14) of the carrier (13) to reduce a gap width between the guiding protrusion (9) of the back plate (5) in the region of the bulging portion (10) and an adjacent part of the disk brake system.

This application claims the benefit of priority to German Patent Application No. 102021214642.2, filed on Dec. 17, 2021, the entire content of which is incorporated herein by reference.

The application relates to a brake pad for a disk brake system and to a disk brake system.

Brake Engineers are in search for robust solutions to suppress squeal noises (tonal loud noises typically appearing in frequencies between 1000 and 16000 Hz) in disk brake systems. Different solutions are known to improve the noise, vibration, and harshness (NVH) characteristics, including a steel shim glued to a back side of a back plate of a brake pad assembly, different chamfers on a pad of the brake pad assembly, slots on pad surfaces contacting the disk, modifications of friction material of the brake pads, an underlayer connecting the friction material to the back plate, and additional massive bodies on certain components like the carrier or the housing. The main effect of the shim is to decouple system modes from each other. While these solutions can help improve the squeal noise characteristics, in most cases these solutions work well only under specific braking conditions (low or high frequency, cold or warm temperature). Prior art can be found, e.g., in document DE 197 06 122 A1.

In view of the above-mentioned aspects, it is an object of the present invention to provide an improved brake pad for a disk brake system. In particular, it is an object of the application to provide a compact and robust brake pad assembly with a low mass at a low cost, which reliably suppresses noise, in particular clicking noise, which appears upon backwards braking, and rattle, i.e., non-harmonic noise typically appearing when driving on a rough road. In addition, it is an object of the application to provide an improved disk brake system having these advantages.

This objective is achieved by a brake pad for a disk brake system comprising the features of claim 1 and by a disk brake system having the features of another claim. Optional further features and further developments will become apparent from the dependent claims and the detailed description in conjunction with the accompanying figures.

The proposed brake pad for a disk brake system comprises a back plate having a front side for facing a brake disk of the disk brake system and a friction layer arranged on the front side of the back plate for contacting a friction surface of the brake disk. The back plate comprises a guiding protrusion configured to be slidably received within a guiding recess of a carrier of the disk brake system. The guiding protrusion may be an ear portion of the back plate. The guiding recess of the carrier may be a guiding groove. The guiding protrusion of the back plate comprises a bulging portion. The bulging portion is configured to extend toward a guiding surface of the guiding recess of the carrier to reduce a gap width between the guiding protrusion of the back plate in the region of the bulging portion and an adjacent part of the disk brake system.

By way of the bulging portion, a more well-defined area of contact between the brake pad and the carrier may be achieved as compared with the prior art.

It was found that one of the main mechanisms that lead to brake noises, especially squeal noises, can be the relative motion between components of the disk brake system, which may contact one another. Relative motion between the brake pad and the carrier in the axial direction may be necessary during braking upon application of the brake and after braking when a brake force is released. However, particularly in known brake systems, such relative motion can lead to an undesired appearance of squeal noise. Also, relative motion in other directions, i.e., radial and tangential directions, may lead to unwanted noise occurrence. The bulging portion lets brake engineers have control over the relative motion between different parts of the disk brake system. Also, the bulging portion enables improved control over the contact areas that occur during such relative motion. It was found that smaller contact areas during relative motion yield an improved dynamic behaviour of the disk brake system. The bulging portion avoids large sliding surfaces that can be a reason for increased noise appearance. Also, the bulging portion may reduce an amount of deflection of the brake pad resulting from brake torque, thereby reducing squeal noise occurrence. Further, the bulging portion being a part of the guiding recess enhances noise reduction, as relative motion and friction forces are specifically reduced in the region that transfers a large share of the forces between the brake pad and the carrier upon brake application. The bulging portion also improves clicking noise, which appears upon backwards braking, and rattle, i.e., non-harmonic noise typically appearing when driving on a rough road. As compared with the prior art, the brake pad of the present invention enables a robust design, which does not change with time or wear (as compared with, e.g., known slots or chamfers). Typically, the bulging portion does not lead to additional mass and cost as compared with known brake pads.

The application further relates to a disk brake system. The disk brake system may comprise the brake pad as described above or below. Further, the disk brake system may comprise the carrier. The brake pad may be configured to slide with respect to the carrier in an axial direction upon brake application. The axial direction may be parallel to an axis of rotation of a brake disk. In most embodiments, the disk brake system is a floating caliper brake. The disk brake system may comprise a brake piston and/or a caliper finger. The brake piston or caliper finger may be configured to push against a back side of the brake pad to push the friction layer of the brake pad against the friction surface of the brake disk.

In some embodiments, the disk brake system comprises a pad spring. The pad spring may be arranged at least in part between the guiding protrusion of the back plate and the guiding recess of the carrier. The pad spring is typically a sheet metal part. In most embodiments, the pad spring is inserted into the guiding recess of the carrier during assembly of the disk brake system. In other embodiments, however, the pad spring is attached to the back plate during assembly of the disk brake system. The pad spring may prevent direct contact between the brake pad and the carrier. The pad spring may have a positive effect on the corrosion behaviour. In addition, the pad spring can further improve an ease of movement of the brake pad relative to the carrier. Further, together with the bulging portion of the guiding protrusion of the back plate, the pad spring may provide support and/or abutment in tangential and radial directions and may achieve a tight fit of the brake pad within the guiding recess of the carrier. Thereby, an unwanted movement and/or rotation of brake pad may be further prevented.

In other embodiments, however, a pad spring is not provided between the guiding protrusion of the back plate and the guiding recess of the carrier. For example, nothing but air may be arranged between the bulging portion of the guiding protrusion of the back plate and the guiding recess of the carrier.

The adjacent part, which may be the part of the disk brake system that is closest to the guiding protrusion in a region of the bulging portion, may hence be one of the carrier, in particular its guiding recess or a guiding surface thereof, or the pad spring that is arranged between the carrier and the brake pad, if the pad spring is provided. The guiding protrusion may comprise a guiding protrusion body. Further, the bulging portion may be attached to the guiding protrusion body. Typically, the bulging portion protrudes, in particular from the guiding protrusion body, toward the adjacent part.

As described above, the bulging portion of the guiding protrusion enables a reduction of a spacing between the carrier and the brake pad for a well-defined contact between the brake pad and the carrier. In most embodiments, the gap width between the guiding protrusion of the back plate in the region of the bulging portion and the adjacent part of the disk brake system, in particular one of the carrier or the pad spring, is at most 0.8 mm, in particular at most 0.6 mm. The gap width may even be reduced to zero in some embodiments, meaning that the bulging portion and the adjacent part essentially touch one another, at least upon application of the brake. In some embodiments, the bulging portion and the adjacent part essentially touch one another also in an unloaded state of the disk brake system. However, it is preferred that that the gap width is at least 0.2 mm, in particular at least 0.4 mm, when the brake is not applied. Typically, the bulging portion is configured to be in direct contact with the adjacent part of the disk brake system upon application of the brake. In case the pad spring is provided, a gap width between the guiding surface of the guiding recess of the carrier and an outer surface of the pad spring in the region of the bulging portion of the guiding protrusion of the back plate of the brake pad is at least 0.4 mm and/or at most 1 mm, for example 0.6 mm.

To further improve brake torque transmission at the interface between the brake pad and the carrier and to reduce relative motion between these parts, the bulging portion may have a rounded section facing the carrier. In this way, relative motion relative motion between the carrier and the brake pad is minimized in a manner that a smooth and small contact surface is achieved. The bulging portion may define a tip portion. A part of the tip portion may form a contact portion of the bulging portion that is configured to come into contact with the adjacent part. The tip portion may be the rounded section. In particular, the the bulging portion may have, at least in part, essentially the shape of a spherical cap in some embodiments. However, in other embodiments, the bulging portion may have, at least in part, essentially the shape of a cylinder section. In this case, a cylinder axis typically corresponds to an axial direction of the disk brake system. The contact portion may in some embodiments be essentially point-like. In other embodiments, the contact portion is essentially line shaped. The line-shaped contact portion typically refers to a line that extends in the axial direction.

However, in preferred embodiments, the tip portion of the bulging portion has a radius of curvature of at most 5 mm. In this manner, an even more well-defined contact area between the brake pad and the carrier may be achieved to further reduce noise occurrence. In particular, the tip portion of the bulging portion has a radius of curvature of at most 3 mm. In the case of the bulging portion having, at least in part, essentially the shape of the cylinder section, a curvature of the tip is to be understood to be a curvature at least in one direction in space.

In some embodiments, the back plate comprises a back plate body. The guiding protrusion of the back plate may protrude in a tangential direction from the back plate body. In this manner, the guiding protrusion may extend in a sideward direction and may define a leading or a trailing portion of the brake pad or a part thereof. The back plate may comprise another guiding protrusion having a bulging portion. The latter may have any or all of the features of the bulging portion of the guiding protrusion. The guiding protrusion may define a leading portion of the brake pad, and the other guiding protrusion may define a trailing portion of the brake pad. The bulging portion of the guiding protrusion and the bulging portion of the other guiding protrusion may differ in size and/or shape, according to some embodiments.

For further improvement of the noise characteristics, the bulging portion may extend in the tangential direction. The bulging portion typically extends from the guiding protrusion body in the tangential direction. It was found that the defined contact provided by the bulging portion further improves noise reduction, when the bulging portion extends in the tangential direction, due to the relative motion of the parts in realistic braking scenarios.

However, in other embodiments, the bulging portion extends in a radial direction. In this embodiment, the bulging portion typically extends from the guiding protrusion body in the radial direction. The radial direction can be an upward and/or a downward direction, meaning a positive or negative radial direction. The radial direction may be perpendicular to the tangential direction. When the bulging portion extends in the radial direction and the guiding protrusion of the back plate extends in the tangential direction from the back plate body, the bulging portion typically forms an undercut portion (as vied in the tangential direction). In this way, further reduction of noise occurrence can be achieved by reducing the radial gap width between the guiding protrusion of the back plate and the adjacent part.

In some embodiments, the guiding protrusion of the back plate comprises a second bulging portion. The second bulging portion may be configured to extend toward the guiding surface of the guiding recess of the carrier to reduce a gap width between the guiding protrusion of the back plate and the adjacent part in the region of the second bulging portion. In this way, control over the area of contact between the brake pad and the carrier can be further improved. The second bulging portion may comprise any or all of the features discussed above or below with regard to the bulging portion.

For example, the bulging portion may extend in the tangential direction, and the second bulging portion may extend in the radial direction. In this way, further control over the relative motion and hence relative contact areas is achieved in the tangential and radial direction using the bulging portion and second bulging portion to further improve the contact and reduce noise occurrence. In other embodiments, however, the bulging portion and the second bulging portion both extend in the tangential direction. Additionally or alternatively the bulging portion and the second bulging portion may both extend in the radial direction. In this way, a well-defined contact can be ensured when the brake pad has a tendency to rotate to some extent. In this embodiment, the bulging portion and the second bulging portion may be arranged side by side on the guiding protrusion body and may extend in the same direction from the guiding protrusion body. In this way, stability may be further increased and noise reduction due to relative motion of the brake pad and the carrier may be improved.

The guiding protrusion may further comprise a third bulging portion. The third bulging portion may comprise any or all of the features discussed above or below with regard to the bulging portion and/or the second bulging portion. For example, the bulging portion may extend in a positive radial direction, e.g., upward, the second bulging portion may extend in the tangential direction, and the third bulging portion may extend in a negative radial direction, e.g., downward. In this way, a reduction of noise occurrence may be achieved by a well-defined contact between the guiding protrusion of the brake pad and the carrier in three directions.

In some embodiments, the guiding protrusion is essentially spherical or essentially cylindrical. This embodiment is an example that can achieve a reduction of noise occurrence by a well-defined contact between the guiding protrusion of the brake pad and the carrier in three directions. In this embodiment, a part or parts of the essentially spherical or essentially cylindrical guiding protrusion form the bulging portion, and in some cases the second bulging portion, and in some cases the third bulging portion. An axial surface, in particular the front and/or back surface of the guiding protrusion, may be flat, so that the essentially spherical guiding protrusion may be a flattened sphere. In this manner, interference of the guiding protrusion with other parts of the disk brake system, e.g., with a retraction spring, may be avoided. In case the guiding protrusion is essentially spherical or essentially cylindrical, it is preferred that the guiding protrusion and/or the tip portion of the bulging portion and/or tip portions of the second and/or third bulging portion has a radius of curvature of at most 10 mm. The guiding recess of the carrier and in particular the guiding surface of the carrier may have a concave curvature at least in regions. The concave curvature may be configured to receive the essentially spherical or essentially cylindrical guiding protrusion.

In some embodiments, at least a part of a surface area of the bulging portion is formed by or covered with a non-stick material. For example, at least a part of a surface area of the bulging portion is formed by or covered with a non-stick coating. In this manner, the stick-slip phenomenon may be reduced to further reduce noises resulting from a relative motion of the brake pad and the adjacent part. The non-stick material for example be polytetrafluoroethylene. In some examples, the bulging portion or at least a part of the bulging portion may be formed by a material that is softer than a material of the guiding protrusion body or a material of the back plate body to further improve the noise characteristics of the disk brake system.

The guiding protrusion body as well as the bulging portion may be formed by a one-piece part. The one-piece part may be a non-joined part or a monolithic part. In this manner, a stable arrangement having good noise characteristics is achieved.

The guiding protrusion body is typically connected to the back plate body. In some embodiments, the guiding protrusion and the back plate body are formed as joined parts. In this way, fabrication of the back plate may be simplified, particularly for the cases that the bulging portion forms an undercut portion, the bulging portion extends in a radial direction, and/or the guiding protrusion is essentially spherical or essentially cylindrical. The guiding protrusion may be screwed to, plugged into, and/or welded to the back plate body.

The back plate and/or the back plate body can be cast or forged. A thickness of the back plate body may be at least 3 mm and/or at most 8 mm, for example 5 mm. A thickness of the guiding protrusion may be at least 2 mm and/or at most 10 mm, for example 5 mm. The back plate and/or the back plate body typically comprises steel, phenolic resin, aluminium, hard plastic, or cast iron or is made thereof. The carrier typically comprises steel, aluminium, or grey iron or is made thereof.

The disk brake system may comprise another brake pad having any or all of the features of the brake pad described above or below. The brake pad may be configured to be pushed on by the caliper finger, while the other brake pad may be configured to be pushed on by the brake piston. The brake pad and the other brake pad may differ in size/or shape, according to some embodiments.

Exemplary embodiments will be described in conjunction with the following figures.

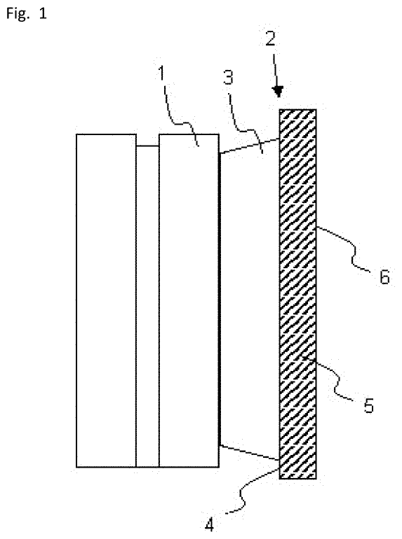

FIG. 1 shows a schematic cross sectional illustration of a brake pad and a brake disk,

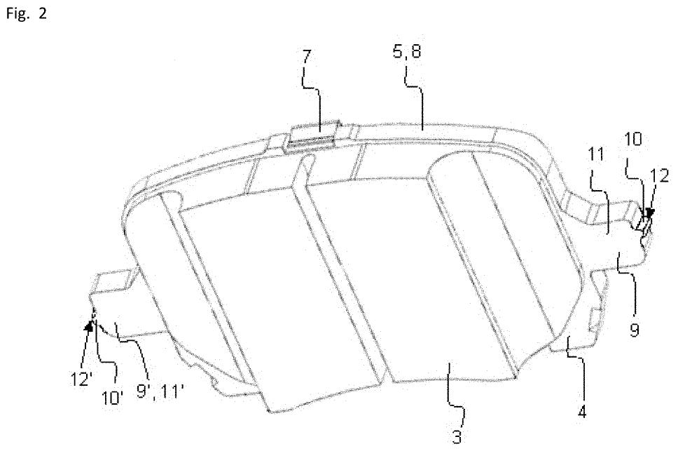

FIG. 2 shows a perspective view of a brake pad,

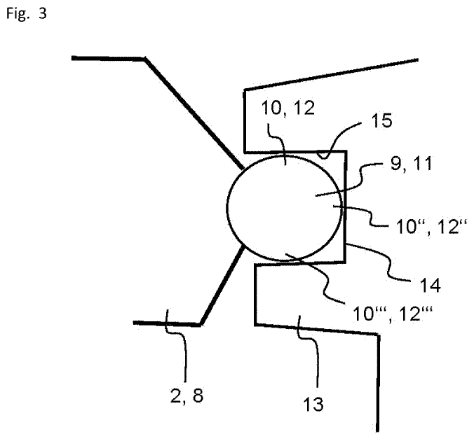

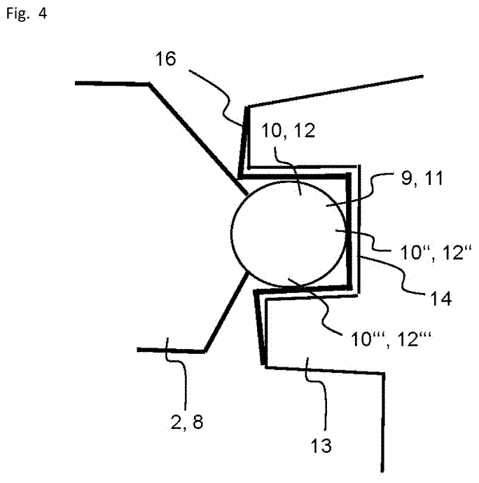

FIGS. 3 and 4 show schematic cross-sectional views of portions of a carrier and the brake pad according to different embodiments,

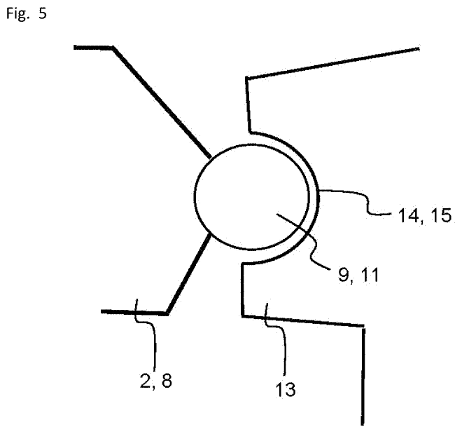

FIGS. 5 to 7 show schematic cross-sectional views of portions of a carrier and the brake pad according to further embodiments,

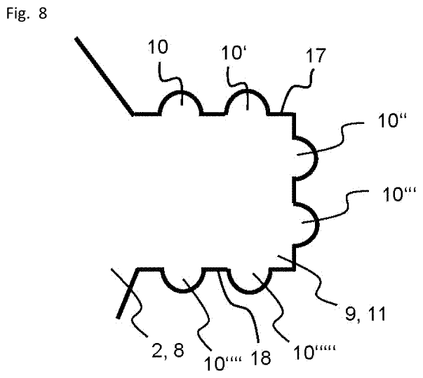

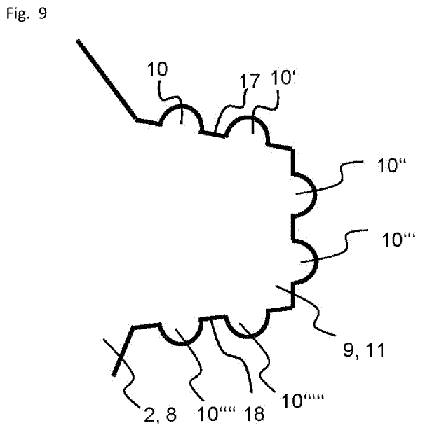

FIGS. 8 and 9 show schematic cross-sectional views of a portion of a back plate according to other embodiments, and

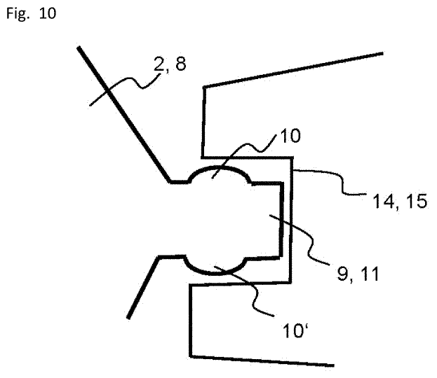

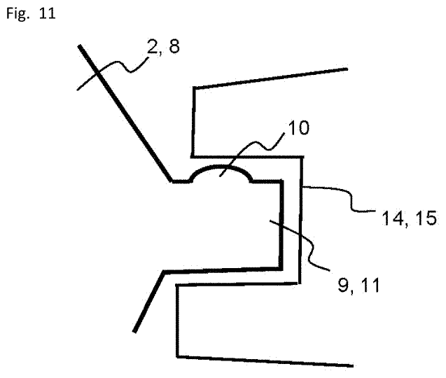

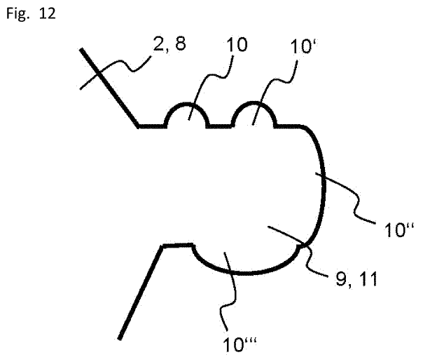

FIGS. 10 to 12 show cross-sectional views according to further embodiments.

FIG. 1 shows a brake disk 1 of a of a disk brake system for a vehicle. The disk brake system may comprise a caliper housing, a caliper finger and a brake piston. The disk brake system further comprises a brake pad 2, which may be attached relative to the caliper finger or to the brake piston such that upon application of the brake the caliper finger or the brake piston pushes the brake pad 2 in an axial direction toward the brake disk 1. The brake pad 2 has a friction layer 3, which is pushed against a friction surface of the brake disk 1 upon actuation of the disk brake system, e.g., hydraulic or electric actuation. The friction layer 3 contains a material that shows a good stopping performance and heat transfer when engaging with the brake disk 1. The friction layer 3 is attached to a front side 4 of a back plate 5, which provides structural stability to the brake pad 2. The brake piston or the caliper finger is configured to push against a back side 6 of the back plate 5 to push the friction layer 3 against the brake disk 1. In most embodiments, the back plate 5 is made of a metal, in particular steel. A thickness of the back plate 5 may be, e.g., 5 mm. The friction layer 3 can have a thickness of at least 8 mm and/or at most 15 mm, for example. The material of the friction layer 3 can for instance comprise at least one of copper, iron sulphide, graphite, zinc powder, basalt, calcium carbonate, tin sulphide, zinc aluminium, phenolic resin, rubber dust and mineral fibre. These materials show good stopping performance and heat transfer when engaging with the brake disk.

FIG. 2 shows a perspective view of a brake pad 2. Corresponding and reoccurring features shown in the different figures are denoted using the same reference numerals. The friction layer 3 of the brake pad 2 is fixed to the front side 4 of the back plate 5. A clip-on-shim 7 is attached to the back side 6 of the back plate 5 for noise dampening. The back plate 5 comprises a back plate body 8 forming the main portion of the back plate 5 and carrying the friction layer 3. The back plate 5 further comprises a pair of guiding protrusions 9, 9′ formed at the two tangential sides of the back plate 5 and each configured to be received within a respective guiding recess of a carrier of the disk brake system. In the embodiment shown, the back plate body 5 and the guiding protrusions 9, 9′ are formed as a one-piece, non-joined part.

The guiding protrusions 9, 9′ each have a bulging portion 10, 10′ extending in a tangential direction from a guiding protrusion body 11, 11′. The bulging portions 10, 10′ reduce a width of a gap between the brake pad 2 and an adjacent part of the disk brake system, e.g., the carrier or a pad spring, and enable a well-defined contact, which was found to lead to a reduction of noise occurrence. The bulging portions 10, 10′ each have a rounded tip portion 12, 12′ facing the guiding recesses of the carrier. The tip portions 12, 12′ can be approximately circular in a cross-section. In the embodiment shown, the tip portions 12, 12′ have the shape of a segment of a cylinder having a cylinder axis in the axial direction. In other embodiments, the tip portions 12, 12′ of the bulging portions 10, 10′ can each have the shape of a spherical cap. The rounded tip portions may have a radius of curvature of, e.g., 2 mm or 3 mm to yield a defined contact area with the carrier. In some embodiments, the bulging portions 10, 10′ are formed together with the guiding protrusion bodies 11, 11′ as a single non-joined part. The bulging portions 10, 10′ may have a PTFE coating and/or may be formed by a material that is softer than the material of the guiding protrusion bodies 11, 11′ in some embodiments.

FIGS. 3 and show schematic cross-sectional views of portions of a carrier 13 and the brake pad 2 according to different embodiments. The brake pad 2 of FIG. 3 has a guiding protrusion 9 that is circular in cross-section. The guiding protrusion 9 may be essentially spherical or cylindrical with a cylinder axis in the axial direction, i.e., into the paper plane in the figure. Rounded sections of the guiding protrusion that extend from the guiding protrusion body 11 into a positive radial direction (upward), a tangential direction (to the right), and a negative direction (downward) form the bulging portion 10 with the tip portion 12, as well as a second bulging portion 10″ with a corresponding tip portion 12″ as well as a third bulging portion 10′″ with a corresponding tip portion 12″′, respectively. The bulging portions extending in the radial direction form undercut portions. In the embodiment shown, a radius or curvature of the bulging and tip portions tip portions can be, e.g., 8 mm or smaller. Particularly in this embodiment, the guiding protrusion 9 and the back plate body 8 may be formed as separate parts attached to one another, e.g., by screwing or welding.

The guiding protrusion 9 of the back plate 5 of the brake pad 2 is slidably received within a guiding recess 14 of the carrier 13. The guiding recess 14 defines guiding surfaces, one of which is marked using reference numeral 15 in the figure. As compared with a rectangular guiding protrusion, the presence of the bulging portions and tip portions as shown in the figures leads to a reduction of a width of a gap between the carrier 13 and the brake pad 2. In the region of the bulging portions 10, 10″, 10″′ the width of the gap is minimal and amounts to less than 0.8 mm, for example 0.4 mm, when the brake is not applied. Upon application of the brake, the bulging portions or at least some of the bulging portions may come in direct contact with the guiding recess 14 of the carrier 13 and form a point-like contact area on the bulging portion in the case of the spherical guiding protrusion 9 or a line-shaped contact area in the case of the cylindrical guiding protrusion 9.

FIG. 4 illustrates that a pad spring 16 (as known in the art) can be arranged between the brake pad 2 and the carrier 13. In this case, the gap width be-tween the pad spring and the guiding protrusion 9 in the region of the bulging portions 10, 10″, 10′″ is, e.g., 0.4 mm. A gap width between the guiding surface 15 of the guiding recess 14 of the carrier 13 and an outer surface of the pad spring 16 in the region of the bulging portions 10, 10″, 10′″ of the guiding protrusion 9 of the back plate 5 of the brake pad 2 is, e.g., 0.6 mm. The pad spring 16 is typically formed by a sheet metal part.

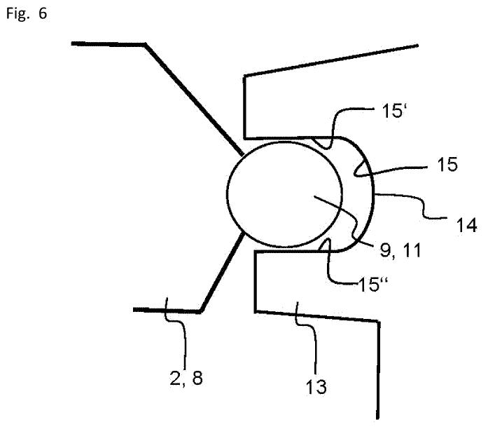

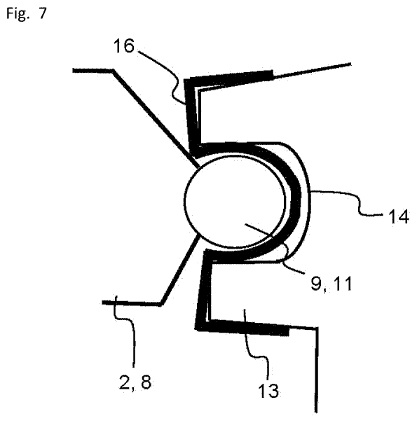

FIGS. 5 to 7 show schematic cross-sectional views of portions of a carrier 13 and the brake pad 2 according to further embodiments. These embodiments correspond to the embodiments discussed above, except that the guiding surface 15 of the guiding recess 14 of the carrier 13 is concave. The guiding recess 14 of the carrier 13 according to the embodiment of FIG. 5 is formed by a half cylindrical recess. The guiding recess 14 shown in FIG. 6 has a guiding recess 14 formed by a concave guiding surface 15 delimiting the guiding recess 14 in the tangential direction and flat guiding surfaces 15′, 15″ delimiting the guiding recess 14 in the positive and negative radial directions, respectively. FIG. 7 illustrates that the pad spring 16 can be provided, as explained above.

FIGS. 8 and 9 illustrate guiding protrusions 9 according to other embodiments. These guiding protrusions 9 have two bulging portions 10, 10′ extending from the guiding protrusion body 11 in the positive radial direction, two bulging portions 10″, 10″′ extending from the guiding protrusion body 11 in the tangential direction, and two bulging portions 10″″, 10″″′ extending from the guiding protrusion body 11 in the negative radial direction. Pairs of the bulging portions are arranged side-by-side. While the guiding protrusion body 11 of FIG. 8 has upper and lower surfaces 17, 18 that are essentially parallel, the upper and lower surfaces 17, 18 of the guiding protrusion body 11 according to the embodiment of FIG. 9 are tapered in the tangential direction.

FIGS. 10 to 12 illustrate cross-sectional views of the guiding protrusion 9 of the back plate 5 of the brake pad 2 according to further embodiments. Features of the different embodiments which are merely disclosed in the exemplary embodiments may be combined with one another and may also be claimed individually.

### LIST OF REFERENCE NUMERALS

1 Brake disk

2 Brake pad

3 Friction layer

4 Front side of back plate

5 Back plate

6 Back side of back plate

7 Clip-on-shim

8 Back plate body

9, 9′ Guiding protrusions

10, 10′, 10″, 10′″, 10″″, 10″″′ Bulging portions

11, 11′ Guiding protrusion bodies

12, 12′ Tip portions

13 Carrier

14 Guiding recess

15, 15′, 15″ Guiding surfaces

16 Pad spring

17 Upper surface of guiding protrusion body

18 Lower surface of guiding protrusion body

1. A brake pad (2) for a disk brake system, comprising
a back plate (5) having a front side (4) for facing a brake disk (1) of the disk brake system and
a friction layer (3) arranged on the front side (4) of the back plate (5) for contacting a friction surface of the brake disk (1),
wherein the back plate (5) comprises a guiding protrusion (9) configured to be slidably received within a guiding recess (14) of a carrier (13) of the disk brake system,
characterized in that the guiding protrusion (9) of the back plate (5) comprises a bulging portion (10) configured to extend toward a guiding surface (15) of the guiding recess (14) of the carrier (13) to reduce a gap width between the guiding protrusion (9) of the back plate (5) in the region of the bulging portion (10) and an adjacent part of the disk brake system.

2. The brake pad (2) of claim 1, characterized in that the back plate (5) comprises a back plate body, wherein the guiding protrusion (9) of the back plate (5) protrudes in a tangential direction from the back plate body.

3. The brake pad (2) of claim 2, characterized in that the bulging portion (10) has, at least in part, essentially the shape of a spherical cap.

4. The brake pad (2) of claim 3, characterized in that the bulging portion (10) defines a tip portion that has a radius of curvature of at most 5 mm.

5. The brake pad (2) of claim 2, characterized in that the bulging portion (10) extends in a tangential direction.

6. The brake pad (2) of claim 5, characterized in that the bulging portion (10) extends in a radial direction.

7. The brake pad (2) of claim 6, characterized in that the guiding protrusion (9) of the back plate (5) comprises a second bulging portion (10″) configured to extend toward the guiding surface (15) of the guiding recess (14) of the carrier (13) to reduce a gap width between the guiding protrusion (9) of the back plate (5) and the adjacent part in the region of the second bulging portion (10″).

8. The brake pad (2) of claim 7, characterized in that the bulging portion (10) and the second bulging portion (10″) both extend in the tangential direction and/or in that the bulging portion (10) and the second bulging (10″) portion both extend in the radial direction.

9. The brake pad (2) of claim 2, characterized in that the guiding protrusion (9) is essentially spherical.

10. The brake pad (2) of claim 1, characterized in that at least a part of a surface area of the bulging portion (10) is formed by or covered with a non-stick material.

11. The brake pad (2) of claim 1, characterized in that the guiding protrusion (9) comprises a guiding protrusion body (11), wherein the bulging portion (10) is attached to the guiding protrusion body (11), and the guiding protrusion body (11) as well as the bulging portion (10) are formed by a one-piece part.

12. The brake pad (2) of claim 1, characterized in that the back plate (5) comprises a back plate body (8), wherein the guiding protrusion (9) and the back plate body (8) are formed as joined parts.

13. A disk brake system comprising a brake pad (2) according to claim 1 and the carrier (13), wherein the brake pad (2) is configured to slide with respect to the carrier (13) in an axial direction upon brake application.

14. The disk brake system of claim 13, characterized in that the gap width between the guiding protrusion (9) of the back plate (5) in the region of the bulging portion (10) and the adjacent part of the disk brake system is at most 0.8 mm.
